(19) United States
(12) Patent Application Publication
(10) Pub. No.: US 2010/0325326 A1
(43) Pub. Date: Dec. 23, 2010

(54) DEVICE INFORMATION MANAGEMENT SYSTEM AND DEVICE INFORMATION MANAGEMENT METHOD

(75) Inventors: CHUNG-CHING HUANG, TAIPEI (TW); YEH CHO, TAIPEI (TW); JIA-HUNG WANG, TAIPEI (TW); KUO-HAN CHANG, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: VIA TECHNOLOGIES, INC., TAIPEI (TW)

(21) Appl. No.: 12/758,274

(22) Filed: Apr. 12, 2010

Related U.S. Application Data
(60) Provisional application No. 61/218,707, filed on Jun. 19, 2009.

(30) Foreign Application Priority Data
Aug. 21, 2009 (TW) 98128199

(51) Int. Cl. G06F 13/40; G06F 13/28; G06F 12/00

(52) U.S. Cl. 710/110; 710/308; 711/102; 711/E12.001

(57) ABSTRACT

A device information management system for managing device information of various peripheral devices is disclosed. The system includes a central processing unit, a logic controller connected with the central processing unit, a first device connected with the logic controller, wherein the first device has a device information stored in a memory unit for identifying the first device, and a second device connected with the first device, wherein the first device outputs an access command to the second device and the second device accesses the memory unit to retrieve the device information of the first device according to the access command.

### REFERENCE TO RELATED APPLICATIONS

This patent application is based on Provisional Patent Application Ser. No. 61/218,707, filed 19 Jun. 2009, currently pending.

### BACKGROUND OF THE INVENTION

1. Field of the Invention

The present invention relates to a device information management system and a device information management method, and more particularly, to a device information management system and a device information management method that is capable of enabling an access to the device information of one peripheral device via another peripheral device.

2. Description of Related Art

For peripheral devices in a computer system to communicate with a processing unit of the computer system, every peripheral device records device information or meta data related to the peripheral device itself in a memory attached to the device, so that the processing unit could identify each peripheral device by recognizing the device information. Take a network interface device for example, every network interface device has a unique Media Access Control (MAC) address as its identifying information. Some peripheral devices' manufacturers have developed Universal Unique ID (UUID) for their own products to enhance the security when it comes to device identification. However, since every peripheral device is associated with a memory unit for storage of its device information, a large number of memory units are necessary, increasing the total cost for manufacturing a computer system and a size of a circuit board for the computer system.

### SUMMARY OF THE INVENTION

The present invention provides a device information management system and a device information management method for various peripheral devices of a computer system. The management system includes a central processing unit, a logic controller connected with the central processing unit, a first device connected with the logic controller, wherein the first device has a device information stored in a memory unit for identifying the first device, and a second device connected with the first device, wherein the first device outputs an access command to the second device and the second device accesses the memory unit to retrieve the device information of the first device according to the access command.

The device information management method is adapted to a computer system. The computer system comprises a peripheral device and a device information stored in a memory unit which is used for identifying the peripheral device, wherein the peripheral device acquires the device information via an embedded controller to access the memory unit. The method comprises: sending out a request for accessing the device information of the peripheral device; establishing a controlling relation between the peripheral device and the embedded controller; and accessing the memory unit according to the request.

Based on the implementation approaches, the device information of each peripheral device in the computer system is stored in one memory unit. When any need for access to the device information arises, peripheral devices could access the corresponding device information through compatible communication interfaces and other peripheral devices. In order to further the understanding regarding the present invention, the following embodiments are provided along with illustrations to facilitate the disclosure of the present invention.

### BRIEF DESCRIPTION OF THE DRAWINGS

FIG. 1 shows a block diagram of an exemplary computer system;

FIG. 2 shows a block diagram of a computer system according to the first embodiment of the present invention;

FIG. 3A shows a block diagram of a computer system according to the second embodiment of the present invention;

FIG. 3B shows a block diagram of a computer system according to the third embodiment of the present invention;

FIG. 4 shows a schematic diagram showing an exemplary data structure according to a memory unit in accordance with one embodiment of the present invention;

FIG. 5 shows a block diagram of a computer system according to the fourth embodiment of the present invention; and

FIG. 6 shows a flow chart of device information management method of a computer system according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

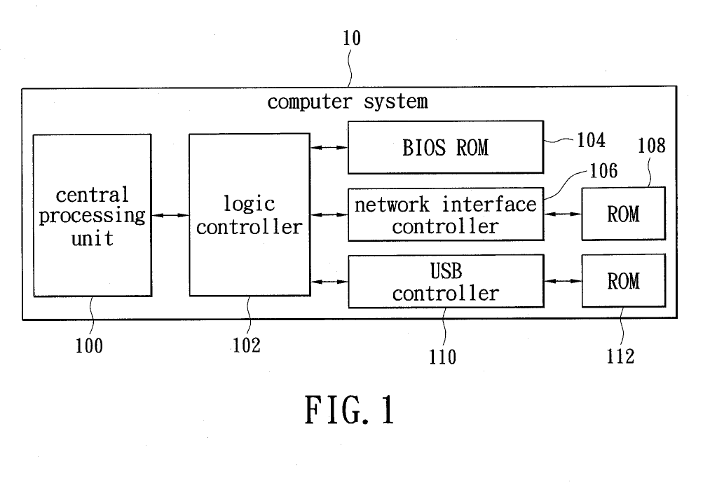

Please refer to FIG. 1, which shows a block diagram of an exemplary computer system 10. Common peripheral devices of the computer system 10 include a basic input output system (BIOS) read-only memory (ROM) 104, a Network Interface Controller 106 (NIC), a Universal Serial Bus (USB) controller 110, and so on. Peripheral devices are coupled to and interact with the central processing unit 100 via a logic controller 102 such as a chipset integrating South Bridge circuitry and North Bridge circuitry.

Generally speaking, each peripheral device is coupled with the ROM where corresponding device information of the peripheral device is stored. A ROM, e.g. electrically-erasable programmable ROM (EEPROM), is a non-volatile memory which ensures the device information stored within, such as the UUID or MAC address of the device, would not be lost after the computer system is shut off.

As shown in FIG. 1, the NIC 106 and the USB controller 110 are connected with ROMs 108 and 112, wherein the device information of the NIC 106 and the USB controller 108 is recorded in the correspondingly connected ROMs 108 and 112. When the NIC 106 requires its device information, e.g. MAC address, the information may be retrieved from the connected ROM 108. Similarly, the USB controller 108 may get the device information directly from the connected ROM 112.

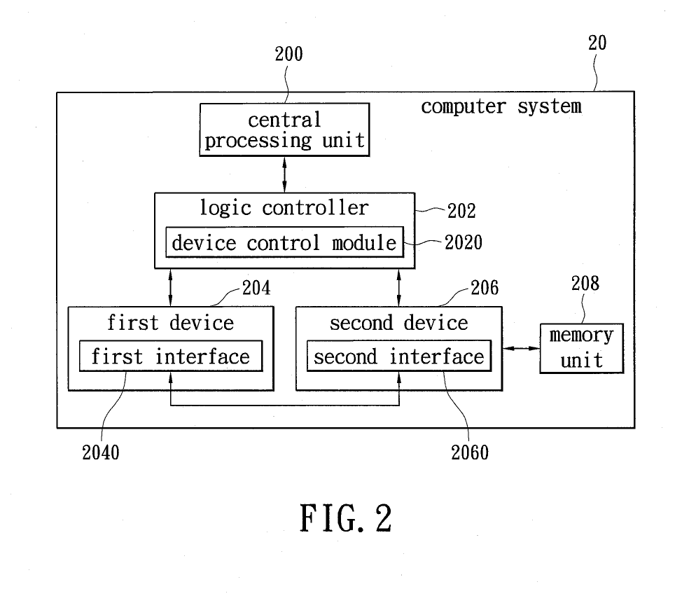

Referring to FIG. 2 which shows a block diagram of a computer system based on the first embodiment of the present invention. The computer system 20 includes a central processing unit 200 (CPU), several peripheral devices, a logic controller 202 (e.g. South Bridge and North Bridge integrated chipset), and a memory unit 208. The logic controller 202 further includes a device control module 2020, such as a South Bridge module. The peripheral devices include a first device 204, and a second device 206, wherein the first device 204 may serve as a master device while the second device 206 may serve as a slave device. Two peripheral devices are illustrated in FIG. 2 as an example, in other embodiments the computer system 20 may have more than two peripheral devices.

In the present embodiment, the device information of the first device 204 is stored in a memory unit 208. The memory unit 208 is controlled by the second device 206. In other words, the first device 204 may need to access the device information stored in the memory unit 208 via the second device 206. In order to do so, the first device 204 may include a first interface 2040 that is compatible with a second interface 2060 of the second device 206. When the first device 204 needs to access its device information, the first device 204 outputs an access command to the second device 206 through the first interface 2040. The second device 206 receives the access command through the second interface 2060 and accesses the targeted device information stored in the memory unit 208 according to the access command. The memory unit 208 may be a non-volatile memory controlled by the second device 206. The memory unit 208 may record the device information of many peripheral devices, and further record some programs related to the second device 206, wherein the programs and the device information may be stored in different sections of the memory unit 208. Comparing to the computer system 10 in FIG. 1, the computer system 20 in FIG. 2 stores the device information of many peripheral devices and programs in a single memory unit 208, eliminating the need of locating different device information from different ROMs.

The access command may be a reading command or a writing command. For example, when the peripheral device is initiated as the computer system 20 boots up, the peripheral devices may need to read the device information before the initiation could be accomplished. For another instance, when any update to the device information (such as renewing the firmware version number) becomes necessary, the CPU 200 may request the peripheral device via a device driver to output a writing command before any updated device information could be written to the corresponding section of the memory unit 208.

In the present embodiment, the second device 206 would record addresses in the memory unit 208 where the device information is stored, in order to correctly access the right device information for the peripheral device outputting commands. Furthermore, the first interface 2040 and the second interface 2060 may both be Inter-Integrated Circuit (I²C) buses, Serial Peripheral Interface (SPI) buses, or other serial interfaces.

The first device 204 according to the present embodiment may be a master device such as a Peripheral Component Interconnect (PCI) controller, a FireWire (also known as IEEE 1394) controller, a USB controller, or a NIC. The second device 206 may be, for example, an Embedded Controller (EC). Since the memory unit 208 may be a non-volatile memory controlled by the second device 206, the memory unit 208 may be an extra memory attached to the EC, a built-in memory within the EC, or a BIOS ROM or Flash ROM. Especially BIOS ROM is one type of Flash ROM and is programmable, In some computer systems, EC programs are saved in the BIOS ROM or Flash ROM along with the device information.

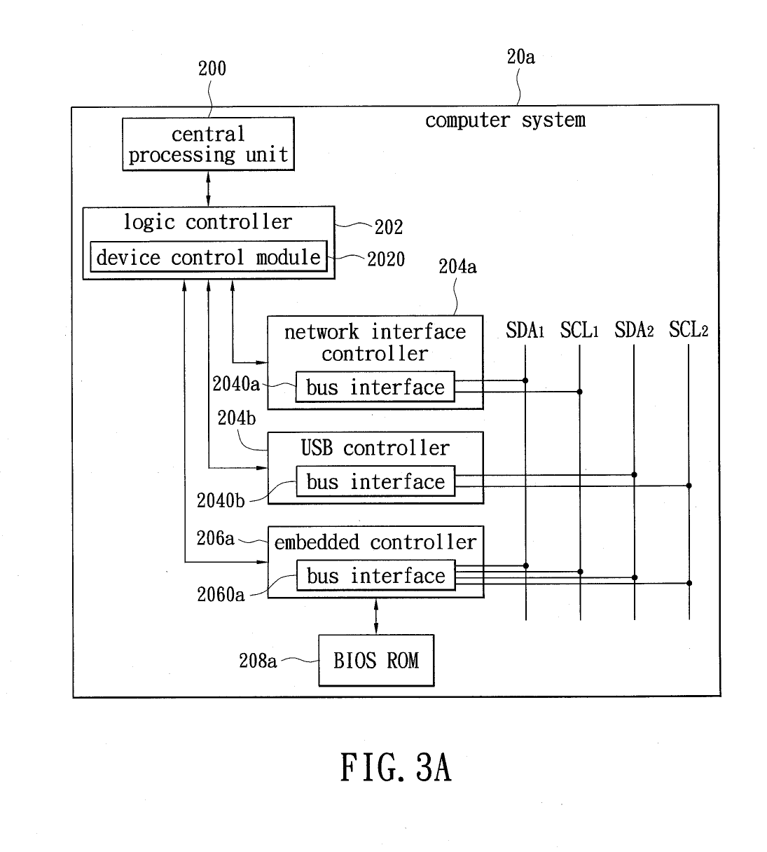

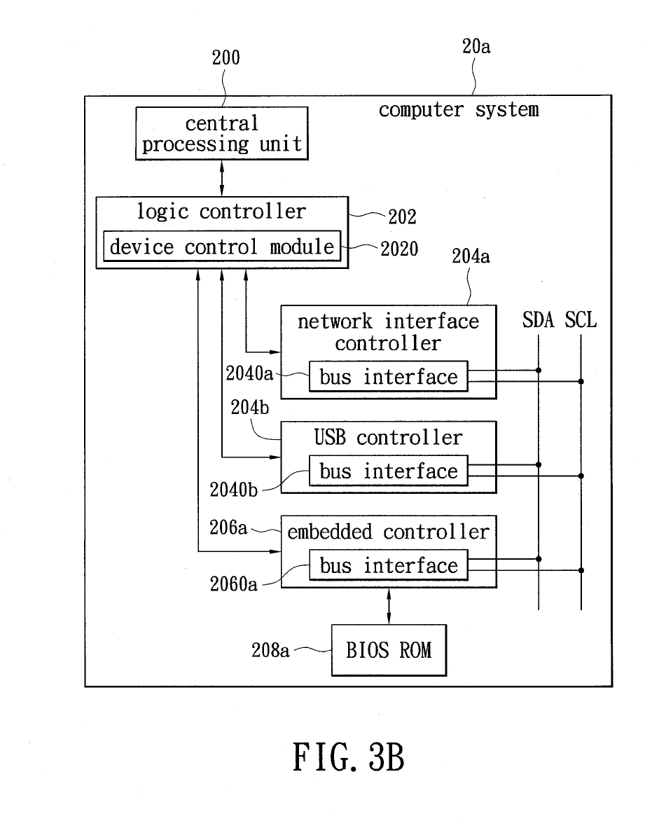

Reference is made to FIG. 3A now, which shows a computer system according to the second embodiment of the present invention. The computer system 20a includes a CPU 200, a logic controller 202, several peripheral devices, and a BIOS ROM 208a. The logic controller 202 further includes a device control module 2020. The peripheral devices are coupled with the CPU 200 via the device control module 2020 and the logic controller 202.

The peripheral devices according to the present embodiment may include an EC 206a, a NIC 204a, and a USB controller 204b. The EC 206a connects to the BIOS 208a through a bus interface. The NIC 204a and the USB controller 204b may, individually, communicate with the EC 206a through bus interfaces 2040a and 2040b of the controllers.

The BIOS ROM 208a are mainly used to store parameters and control programs for initiating the computer system 20a, and yet may have some unused memory space, and therefore, the device information of the peripheral devices and the EC 206a programs may be stored in the memory space that has not yet been utilized. The device information of said peripheral devices may include, for instance, the firmware, programmable codes, UUID, MAC address, and serial number of the device, and so on.

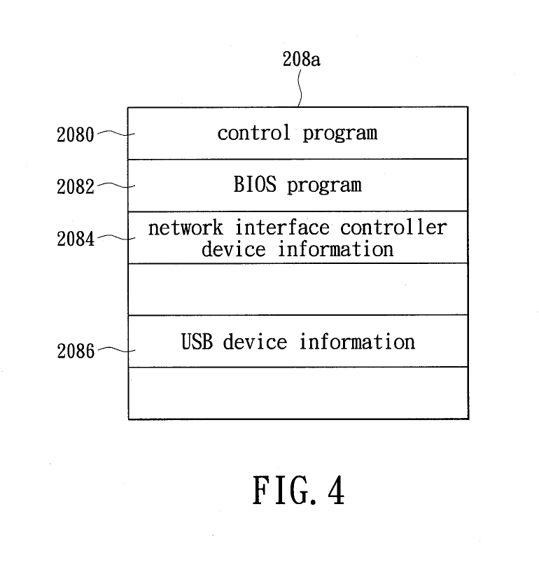

The memory unit of the present invention includes multiple memory sections and separately stores the abovementioned information and programs. Please refer to FIG. 4, which is a schematic diagram showing an exemplary data structure of the memory unit in accordance with one embodiment of the present invention. In conjunction with FIG. 3, the memory unit 208a is divided into several memory sections, wherein each of the sections is used for storing control programs 2080 of the EC 206a, BIOS programs 2082, the network interface controller information 2084, and the USB device information 2086. Other sections of the memory unit 208a not labeled may store other data used in the computer system 20a. When the computer system 20a boots up, the control programs 2080 of the EC 206a and the BIOS program 2082 would be loaded to a main memory of the computer system 20a for the performance of some essential functions of the computer system 20a. Therefore, the control programs 2080 and the BIOS programs 2082 are usually stored at the beginning sections of the memory unit 208a. Other peripheral devices' information may be pre-assigned to different specific sections of the memory unit 208a. If the computer system 20a requires the device information of a particular peripheral device, it needs only the address of the memory section where the device information of that peripheral device is stored, e.g. the start address of the device information, in order to successfully access the device information.

Refer to FIG. 3A again, due to the vital role of the BIOS to the computer system 20a, normally, only the EC 206a is allowed to access the BIOS ROM 208a while the peripheral devices are not. The present invention uses the EC 206a as an intermediate between the BIOS ROM 208a and the peripheral devices 204a and 204b. Each peripheral device is configured to communicate with the EC 206a through bus interfaces for reading the device information stored in the BIOS ROM 208a and writing the same to the BIOS ROM 208a. In particular, when one of the peripheral devices acts as a master device outputting a command for accessing the device information, the EC 206a as a slave device may receive the command transmitted through the bus interface 2040a or 2040b from the master device and access the device information in the BIOS ROM 208a according to the command.

The bus interface of the present invention may further support a multi-master architecture. In other words, several peripheral devices may be connected to the same bus interface at the same time though only one of the buses may be treated as the master device. The bus interface, for instance, may be an I²C bus, a SPI bus or other serial interfaces. Take the I²C bus as an example, as shown in FIG. 3A, an I²C bus includes two signal lines of a serial clock (SCL) line and a serial data (SDA) line. Each peripheral device has signal lines of a serial clock (SCL) line and a serial data (SDA) line, such as SCL₁ and SDA₁ of the NIC 204a or SCL₂ and SDA₂ of the USB controller 204b. In another embodiment, each peripheral device may use the same signal lines of a serial clock (SCL) line and a serial data (SDA) line via an arbiter (not shown), as shown in FIG. 3B. The master device selects the slave device via the serial clock line and transmits data via the serial data line.

When the computer system 20a boots up initializing the network interface controller 204a, the computer system 20a may send out a request to cause the network interface controller 204a to report the MAC address. The network interface controller 204a may serve as the master device when caused by the computer system 20a to report the MAC address with the EC 206a serving as the slave device. In order to establish a controlling relation between the network interface controller 204a and the EC 206a, the network interface controller 204a selects the EC 206a through the bus interfaces 2040a and 2060a. Then, the network interface controller 204a further outputs a reading command according to the request to the EC 206a through the bus interfaces 2040a and 2060a. In turn, the EC 206a may access the BIOS ROM 208a to read the device information including the MAC address of the network interface controller 204a from the corresponding addresses in the EC 206a, and transmits the retrieved device information back to the network interface controller 204a.

It is similar in updating the device information. For instance, if the computer system 20a attempts to update the USB device information 2086 (as shown in FIG. 4), a USB driver would send a request via the CPU 200 and the device control module 2020 to demand the USB controller 204b to access the USB device information 2086. The USB controller 204b may output a writing command to the EC 206a through the bus interface 2040b and 2060a, establishing the controlling relation between the USB controller 204b, which is the master device in this instance, and the EC 206a, which is the slave device, and transmits the updated USB device information to the BIOS ROM 208a via the EC 206a.

The bus interface 2040a and 2060a may be implemented by general purpose input output (GPIO) pins in another implementation where one GPIO pin may be set as a serial clock line and another one may be set as a serial data line to function as the I²C bus.

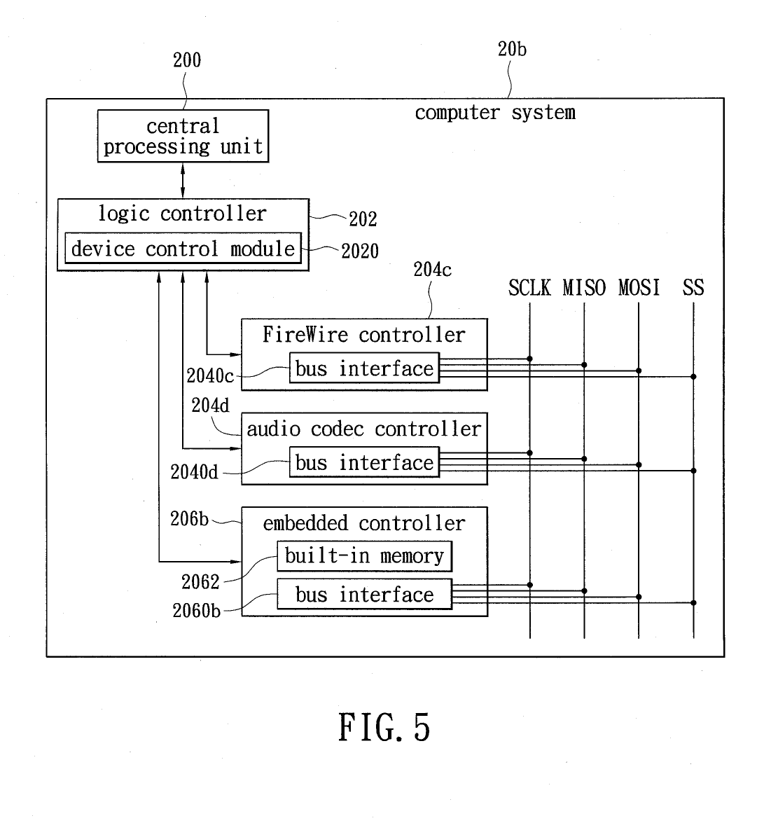

Furthermore, the SPI bus may also be implemented as the bus interface. Please refer to the fourth embodiment according to the present invention shown in FIG. 5.

The device information of peripheral devices may be stored in a built-in memory 2062 of the EC 206b according to the fourth embodiment. The EC 206b may be the slave device in the present example, wherein the FireWire controller 204c and the audio codec controller 204d may be the master device. The bus interface 2060b of the EC 206b, and the bus interfaces 2040c of the FireWire controller 204c and the bus interface 2040d of the audio codec controller 204d may all compatible with the interface of the SPI bus. A SPI bus generally comprises 4 lines: a serial clock (SCLK) line, a master out slave in (MOSI) line, a master in slave out (MISO) line, and a slave select (SS) line.

According to the fourth embodiment, when the FireWire controller 204c instructs the EC 206b to read the device information stored in the built-in memory 2062, the controller 204c would adjust the clock through the SCLK line, and pulls down a voltage level of the SS line of the bus interface 2040c in order to select the EC 206b as the slave device. The reading command may be sent out from the MOSI line to the EC 206b. The corresponding line of the EC 206b is configured to receive the reading command, and the EC 206b interprets the command so as to access the built-in memory 2062 and read the device information related to the FireWire controller 204c. The read device information may be transmitted back to the FireWire controller 204c from the MISO line, and recorded into a random access memory (not shown) of the controller 204c. Therefore, the CPU 200 and the device control module 202 would be able to interact with the FireWire controller 204c.

In an attempt to update the device information of the audio codec controller 204d, an audio codec driver may cause the CPU 200 to send a request to the audio codec controller 204d. The audio codec controller 204d selects the EC 206b as the slave device, sends the writing command, and then writes the updated device information to the corresponding sections of the built-in memory 2062 in the EC 206b. The bus interface 2060b of the EC 206b may also be implemented by GPIO pins.

According to the abovementioned descriptions, a computer system may successfully access various peripheral devices' information stored in one memory via master-slave bus interfaces supporting transmission of commands between master devices and slave devices. The approach also reduces the cost by decreasing the number of EEPROMs installed in the computer system.

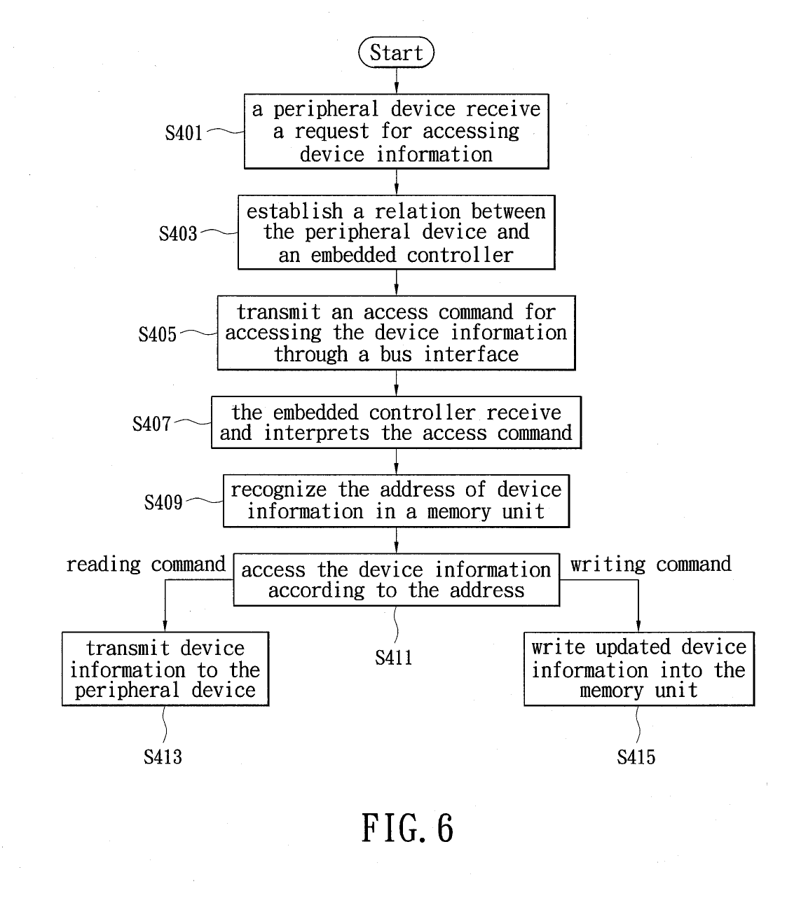

FIG. 6 illustrates a flowchart of a device information management method of a computer system according to an embodiment of the present invention.

Firstly, the computer system sends out a request for accessing device information of a peripheral device when initiating the peripheral device or trying to update the device information (S401). The peripheral device then establishes the controlling relation with an EC, such as setting the peripheral device to be a master device and the EC to be a slave device (S403). The peripheral device may output an access command to the EC through a bus interface like an I²C bus, a SPI bus or other serial interfaces (S405), wherein the access command may be a reading command when the peripheral device is initiated or a writing command when any update to the device information is necessary. The EC receives the access command through the bus interface and interprets the access command (S407), recognizes the address of the corresponding device information in the memory unit (S409), and then accesses the device information (S411). The device information may be transmitted to the peripheral device as the access command is a reading command (S413), and the updated device information may be written into the corresponding address in the memory unit as the access command is a writing command (S415).

Based on the abovementioned disclosure, the present invention features the peripheral devices with master-slave bus interfaces to establish the communications between the peripheral devices. The present invention also sets the peripheral device which is able to access the memory unit as the slave device, while setting another peripheral device with the requirement in accessing the device information as the master device. As such, the master device may access the device information via the slave device. Hence, it may successfully reduce the cost of manufacturing a conventional computer system when each peripheral device should be associated with a memory unit and eliminate the need of a large motherboard in response to the large number of the memory units. In addition, the communication between the CPU, the logic controller, and the peripheral devices of the computer system may remain the same as compared with the traditional approaches despite the peripheral devices according to the present invention are no longer associated with their corresponding memory units.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A computer system, comprising:
a central processing unit;
a logic controller, connected with the central processing unit;
a first device, connected with the logic controller, wherein the first device has a device information stored in a memory unit for identifying the first device; and
a second device, connected with the first device, wherein the first device outputs an access command to the second device and the second device accesses the memory unit to retrieve the device information of the first device according to the access command.

2. The computer system according to claim 1, wherein the first device comprises a first interface through which the first device outputs the access command to the second device, and the second device comprises a second interface through which the second device receives the access command.

3. The computer system according to claim 2, wherein the first interface and the second interface are both an inter-integrated circuit bus or a serial peripheral interface bus.

4. The computer system according to claim 1, wherein the first device is a network interface controller, a USB controller, a FireWire controller, or an audio codec controller.

5. The computer system according to claim 1, wherein the second device is an embedded controller.

6. The computer system according to claim 1, wherein the memory unit is a non-volatile memory built in or attached to the second device, or a BIOS ROM.

7. The computer system according to claim 1, wherein the central processing unit sends a request to the first device based on a driving program, the first device outputs a writing command according to the request, and the second device updates the device information of the first device stored in the memory unit based on the writing command.

8. The computer system according to claim 1, wherein the computer system sends a request to the first device when the first device is initiated, and the first device outputs a reading command to the second device and reads the device information stored in the memory unit via the second device.

9. The computer system according to claim 1, wherein the first device is a master device, and the second device is a slave device.

10. A device information management system, comprising:
a peripheral device having a device information stored in a memory unit for identifying the peripheral device; and
an embedded controller, wherein the peripheral device accesses the device information from the memory unit via the embedded controller.

11. The device information management system according to claim 10, wherein the peripheral device outputs a writing command to the embedded controller, and renews the device information of the peripheral device via the embedded controller.

12. The device information management system according to claim 10, wherein the peripheral device outputs a reading command to the embedded controller and reads the device information of the peripheral device stored in the memory unit via the embedded controller when the peripheral device is initiated.

13. The device information management system according to claim 10, wherein the peripheral device and the embedded controller respectively comprises a bus interface through which the peripheral device outputs an access command to the embedded controller, causing the embedded controller to access the memory unit.

14. The device information management system according to claim 13, wherein the bus interface is an inter-integrated circuit bus or a peripheral component interconnect bus.

15. A device information management method, adapted to a computer system comprising a peripheral device and a device information stored in a memory unit which is used for identifying the peripheral device, wherein the peripheral device acquires the device information via an embedded controller to access the memory unit, the method comprising:
sending out a request for accessing the device information of the peripheral device;
establishing a controlling relation between the peripheral device and the embedded controller; and
accessing the memory unit according to the request.

16. The device information management method according to claim 15, wherein the request is a writing command used for updating the device information of the peripheral device.

17. The device information management method according to claim 15, wherein the request is a reading command, which is sent out for reading the device information of the peripheral device when the peripheral device is initiated.

18. The device information management method according to claim 15, further comprising:
setting the peripheral device as a master device and setting the embedded controller as a slave device so as to establish the controlling relation between the peripheral device and the embedded controller.

19. The device information management method according to claim 15, wherein the peripheral device sends out the request to the embedded controller through a bus interface, and the embedded controller reads or writes the device information based on the request.

20. The device information management method according to claim 19, wherein the bus interface is an inter-integrated circuit bus or a serial peripheral interface bus.
